(19) United States
(12) Patent Application Publication
(10) Pub. No.: US 2016/0034412 A1
(43) Pub. Date: Feb. 4, 2016

(54) PCI EXPRESS CLUSTER

(71) Applicants: Michael Feldman, Thornhill (CA); Boris Feldman, Thornhill (CA)

(72) Inventors: Michael Feldman, Thornhill (CA); Boris Feldman, Thornhill (CA)

(21) Appl. No.: 14/450,273

(22) Filed: Aug. 3, 2014

(51) Int. Cl. G06F 13/40; G06F 13/42

(52) U.S. Cl. CPC G06F 13/4027; G06F 13/4221

(57) ABSTRACT

PCI Express Cluster dedicated for system expansion through installation of up to four high-performance PCI Express boards (example: graphics processing units—GPU).

Cluster includes a special chassis and a backplane. Add-in PCI Express boards are plugged into PCI Express connectors that are located on both sides of the backplane (two on the top side and two on the bottom side); said boards are specially oriented, relative to each other, thereby ensuring that all component sides of said four PCI Express boards will be directed outwards.

This type of PCI Express board placement allows the cooling fans, located on the component side of each PCI Express board, to intake cooling air at ambient temperature, and to eliminate the possibility of airflow obstruction or intake of air that has already been heated by nearby boards.

PCI Express Cluster can be connected to host computer in the first implementation or operate independently as a stand-alone device in the second implementation.

### FIELD OF THE INVENTION

The present invention relates to the field of high-performance computer technology, and in particular, to a cluster apparatus intended for a compact arrangement of four high-performance PCI Express boards.

### BACKGROUND OF THE INVENTION

Improving the performance of computer systems is an ongoing trend of technological advancement. The most popular computer systems use different combinations of a general-purpose processor (CPU) and one or more high-performance PCI Express boards or PCI Express Video boards based on graphics processing unit (GPU).

The high-performance PCI Express boards use the high-bandwidth ×16 PCI Express Gen2 or Gen3 interface having the unidirectional bandwidth 5 Gbit/sec or 8 Gbit/sec. and require a group of ×16 PCI Express connectors on the motherboard. The traditional motherboards usually have a group of said ×16 PCI Express connectors placed in parallel to each other and pointing in one direction.

In case of installing high-performance PCI Express boards into traditional motherboard they will be located in parallel to each other, and all PCI Express brackets of said PCI Express board will be oriented in one direction.

Modern high-performance PCI Express boards operating at extremely high frequency produce huge amount of heat. Therefore, each high-performance PCI Express board has one or more fans for its cooling. These fans are mounted on the top of heat sinks that are placed on the most powerful integrated circuits. All powerful integrated circuits that are provided with such heat sinks and fans are placed on the component side of the PCI Express boards.

The high-performance PCI Express board fans intake cooling air from outside the PCI Express board. The air flow is drawn in perpendicularly into the PCI Express board and moves further along said board to the PCI Express bracket area and goes out through the ventilation holes located on the PCI Express board bracket.

In case when system has multiple said high-performance PCI Express boards and all boards are placed in parallel then each board receives a cooling air after said air has passed along the rear surface of the adjacent board. Obviously, in this case incoming cooling air will be preheated by adjacent board and it will reduce cooling efficiency of said PCI Express board. The quality of cooling will affect the performance of the PCI Express board because in this case said PCI Express boards cannot operate at the maximum speed.

Because of the mechanical dimensions of the PCI Express board heat sinks and fans said high-performance PCI Express boards occupy the space that is equal to two or even three PCI Express slots on the motherboard. The PCISIG organization that regulate all PCI Express board specifications created the special specification for high-performance PCI Express boards where increased allowable thickness of the high-performance PCI Express board. (“PCI Express 225 W/300 W High Power Card Electromechanical Specification Revision 1.0”)

Therefore the traditional motherboards have a problem with the number of PCI Express boards that can be installed in the system. Usually only small number of motherboards allow installing four two-slot wide high-performance PCI Express boards. In the case of three-slot wide PCI Express boards their number will be less. This size limitation of the motherboard is due to the fact that signal distortion (PCI Express interface signals have low signal amplitude and 5 or 8 Ghz frequency) significantly limits the number of PCI Express connections on the motherboard and length of the PCI Express signals.

To solve this problem NVIDIA represents NVIDIA Quadro Plex 2200 D2 made in the format of the separate desktop (outside the computer). Then, this model was transformed into a format 3U server version for installation in a server rack using a horizontal positioning of said high-performance boards and further in the server option NVIDIA Quadro Plex 2200 S4 (format 1U) for 4 GPU.

US Pat. Appl. 20140047156 (E. Billi) represents a hybrid system, wherein to arrange high-performance board (GPU, DSP, etc) the separate crate for vertical positioning boards is used. These vertical boards are parallel and similarly oriented (all component sides are located on one side).

US Pat. Appl. 20140063765 (Kashiwakura K.) and US Pat. Appl. 20140049931 (Wellbrock G. A. et al) also represent groups of parallel boards having the same orientation.

US Pat. Appl. 20130329392 (Czuba K., et al) represents a design, wherein two different types of backplane are used. Correspondingly, the offered backplane configuration for use in an electronic crate system includes two mechanical connected and spatially separated backplanes that reduces an electromagnetic interference between said backplanes and boards installed to said backplanes. These backplanes are connected to each other so that their surfaces, on which different board are installed are oriented on different sides. Each backplane is intended for support only specific type of the boards: AMC boards (Advanced Mezzanine Card) and the RTM boards (Rear Transition Module). However, said separation doesn't remove the heating problem, because within each set of boards belonging to each of said groups, said boards also are located in parallel.

US Pat. Appl. 20140085812 (Ehlen J. B.) offered a successful, but a very complex design intended for mounting a plurality of Storage Drives. In this design a plurality of Backplanes are located on the surface of a circular cylinder, inside which special air channel passes. Said Storage Drives are inserted radially into the slots of said backplanes. Said design is intended only for big quantity of said boards and is not efficient for the wide boards like 2-3 slot wide PCI Express boards.

However, these backplanes do not allow efficient cooling in case of the close placement said high-performance boards.

### BRIEF SUMMARY OF THE INVENTION

The first aspect of the present invention consists in that offered cluster allows ensuring maximum proximity of four connectors for installing said PCI Express boards.

The second aspect consists in that offered PCI Express cluster backplane allows installing four high-performance PCI Express boards so that their component sides, on which the cooling fans are located, are oriented in opposite directions, and, therefore, said fans receive unheated ambient air for PCI Express board cooling.

The third aspect consists in that said PCI Express connectors for plug-in PCI Express boards are located on both surfaces of offered backplane that reduces the size of the PCI Express Cluster and length of the high-frequency PCI Express signals.

The fourth aspect consists in that all four PCI Express boards are additionally fastened to special shelves of offered chassis by their brackets.

The fifth aspect consists in that said offered chassis includes four said shelves intended for fastening said four boards and two shelves for fastening said backplane.

The sixth aspect consists in offering a cost-effective chassis for holding add-in PCI Express boards and said backplane, and said chassis comprises 2 sections, each side includes 3 shelves connected in series like three stairs, and wherein said sections are connected to each other by said backplane. The opposite edges of said backplane are attached to the middle shelves of each of said sections.

The seventh aspect consists in that all said shelves and all connections of them are made from metallic flat bars, tubes, or special profiles.

The eighth aspect consists in that first PCI Express Cluster implementation includes a PCI Express switch (for example, PEX8608), connected to said PCI Express connectors and located on said backplane and a PCI Express cable connector intended for connecting to an external Host computer via PCI Express cable, and also a Power connector for connecting to Power source for said backplane and add-in PCI Express boards.

The ninth aspect consists in that second PCI Express Cluster implementation, wherein the control Host Computer is implemented on said backplane and includes a Central Processor Unit (performing functions of the PCI Express switch) memory blocks, necessary peripheral devices or connectors for connecting to corresponding external devices, and also a Power connector for connecting to Power source.

The tenth aspect consists in that offered Cluster's chassis design allows using not only one-slot wide PCI Express boards, but also two-slot or three-slot wide PCI Express boards.

This summary is provided to introduce a selection of concepts in a simplified form. These concepts are further described below in the detailed description of the preferred implementations. This summary is not intended to identify key features or essential features of the claimed subject matter, nor is it intended to be used to limit the scope of the claimed subject matter.

### BRIEF DESCRIPTION OF THE SEVERAL VIEW OF THE INVENTION

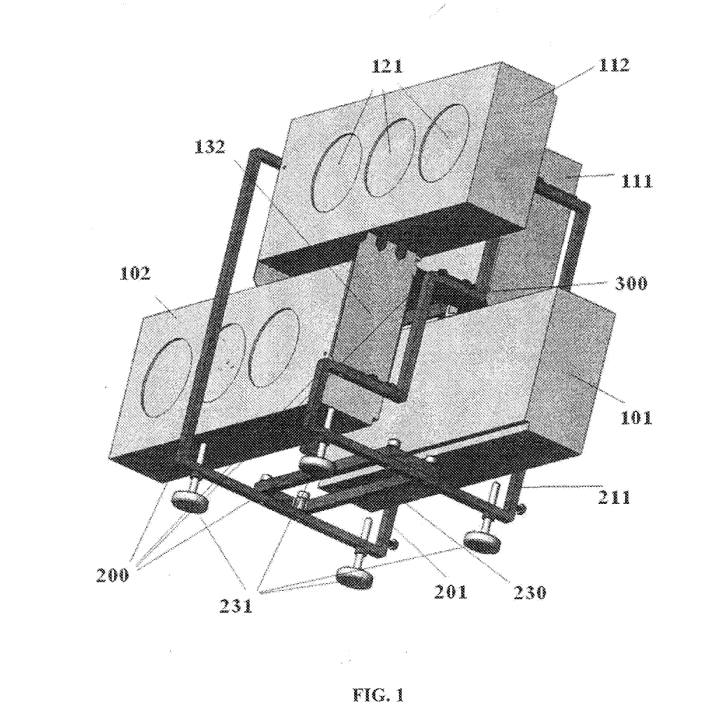

FIG. 1 represents a view of said PCI Express Cluster with add-in PCI Express boards.

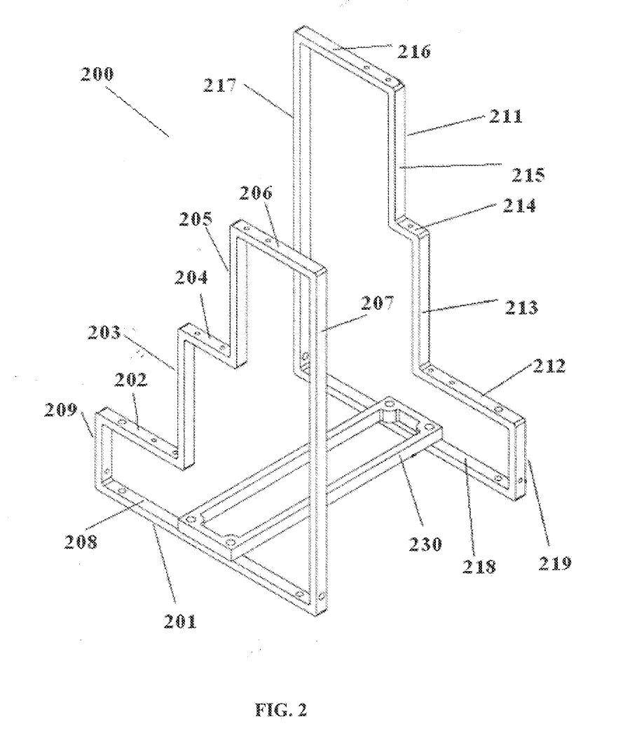

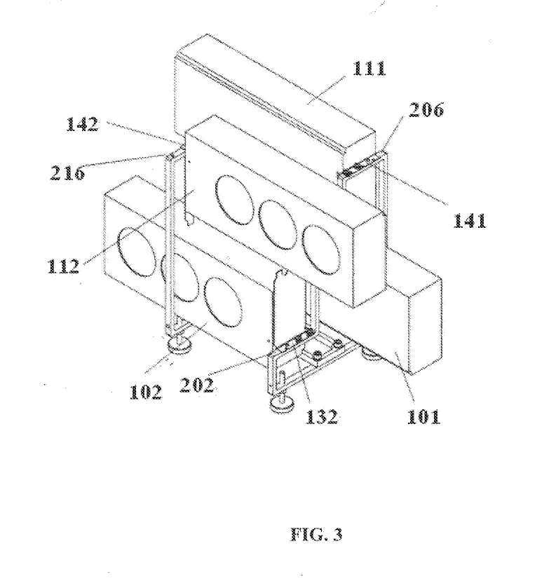

FIG. 2 represents a view of a chassis.

FIG. 3 shows PCI Express Cluster with add-in PCI Express boards.

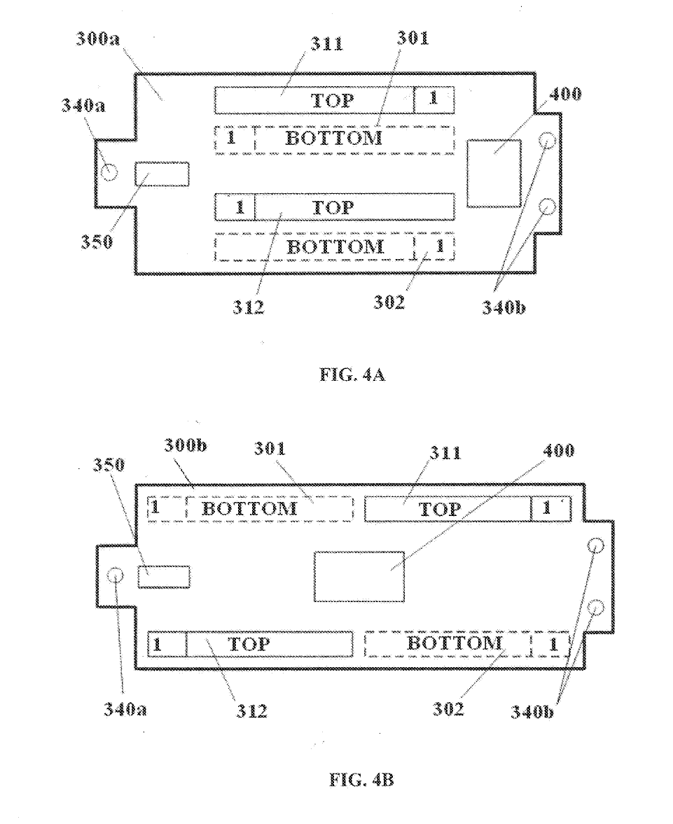

FIGS. 4A and 4B represent two possible arrangements of components on said backplane.

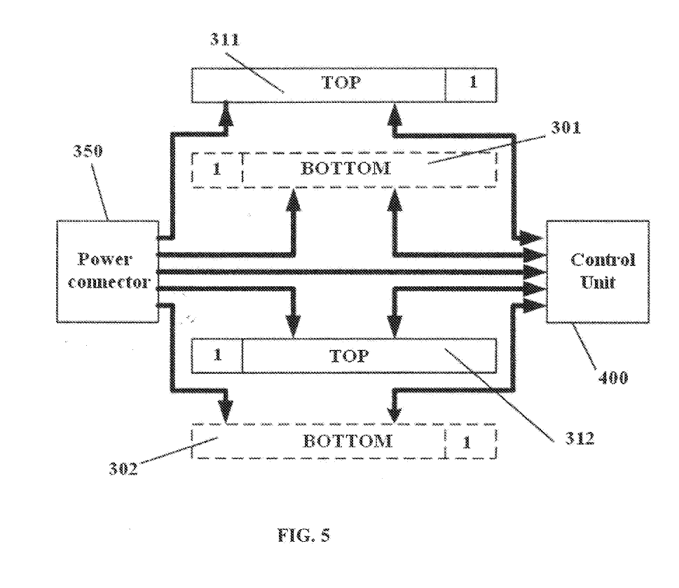

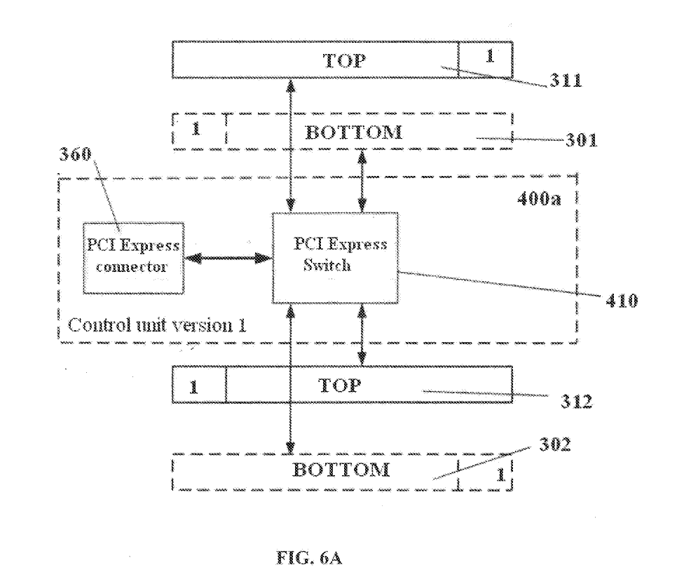

FIG. 5 illustrates connections on the backplane between said four PCI Express connectors, the Power connector and a Control Unit mounted on said backplane.

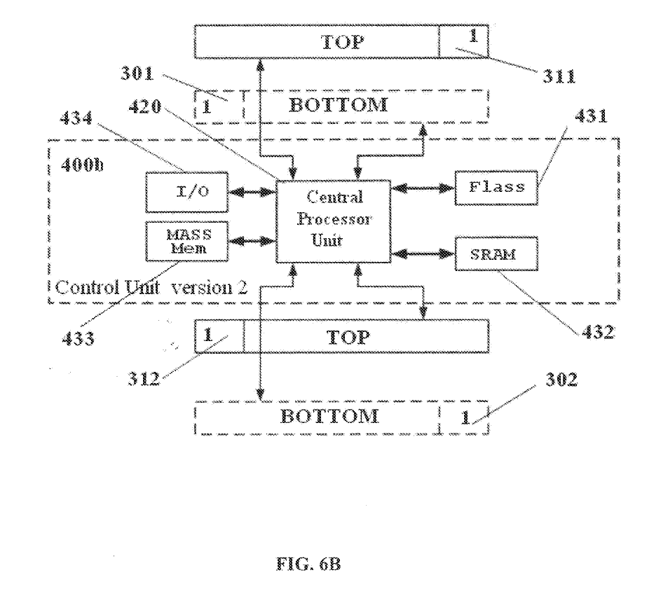

FIGS. 6A and 6B represent two diagrams illustrating two different implementations of said Control Unit; FIG. 6A represents the first implementation wherein PCI Express Cluster is an expansion to Host computer; FIG. 6B represents the second implementation, wherein the Control Unit carries out functions of the Host Computer.

### DETAIL DESCRIPTION OF THE INVENTION

FIG. 1 represents a view of said PCI Express Cluster, comprising a chassis 200 (one of possible implementations), and four add-in PCI Express high-performance boards 101, 111, 102, and 112. Said chassis 200 consists of two sections 201 and 211, and said sections are connected by a jumper 230 and a backplane 300 made from printed circuit board (PCB). Said chassis is standing on supports 231. Four high-performance PCI Express boards (101, 111, 102, and 112) are plugged-in to said backplane 300 and fixed into said chassis by their PCI Express brackets. The bracket 132 belonging to said board 102 is shown in FIG. 1. Said PCI Express boards can have a cooling fan or multiple fans allocated on the component side of said boards. Multiple fans 121 allocated on the component side of the PCI Express board 112 are shown in the FIG. 1.

FIG. 2 represents one of possible implementations of said chassis 200. This chassis consists of two separate sections 201 and 211. Each said section comprises three shelves. Each of said shelf and also each connecting element (further) are made from a bar that is can be produced in the form of tube, flat bar or special profile. The first section 201 includes three shelves 202, 204, 206 and connecting elements 203, 205. Said shelves 202, 204, 206 are combining together by said connecting elements 203, 205 in incremental staircase form. The second section 211 consists of three shelves 212, 214, 216 and connecting elements 213, 215. Said shelves 212, 214, 216 are combining together by said connecting elements 213, 215 in incremental staircase form. These shelves are located on three different levels. Each pair of two shelves 202/212, 204/214, and 206/216, belonging to different sections are located on the same level. Both said sections are connected to each other by said jumper 230 and backplane 300 (FIG. 1). Backplane 300 connecting two middle shelves 204 and 214. Said flights of stairs of the different sections are oriented in opposite directions, the second section is rotated by 180° about vertical axis compare to first section. The upper shelves 206 and 216 and the lower shelves 202 and 212 are intended for fastening said PCI Express brackets. Said first section 201 includes the first open polygon consisting of connecting elements 207, 208, 209. Said first open polygon is connected a left (in FIG. 2) end of shelf 202, jumper 230 and a right end of shelf 206. Said second section 213 includes the second open polygon consisting of connecting elements 217, 218, 219. Said open polygon is connected a left (in FIG. 2) end of shelf 217 and a right end of shelf 212. Bottom connecting elements 208 and 218 of each section are connected to said jumper 230.

FIG. 3 illustrates how said PCI Express add-in boards are mounted relative to each other and how their PCI Express bracket attached to the chassis 200 (Fig. 1). The upper two PCI Express boards 111 and 112 are inserted into corresponding PCI express connectors on the upper side of said backplane 300 (not shown) and PCI Express brackets 141 (belonging to PCI Express board 111) and 142 (belonging to PCI Express board 112) are fastened to the upper shelves 206 and 216 correspondently. The bottom PCI Express boards 101 and 102 are inserted into corresponding PCI Express connectors on the bottom side of said backplane 300 (not shown), and PCI Express brackets 132 (belonging to the PCI Express boards 102) is fastened to the top surface of the shelf 202. The PCI Express bracket belonging to PCI Express board 101 is fastened to the top surface of the self 212 (the bracket of PCI Express boards 101 is not shown). And further FIG. 3 shows that component sides of said inserted PCI Express boards 102, 112 and 101, 111 located on another side are faced outward.

FIG. 4A and FIG. 4B represent two possible implementations of the backplane 300 (correspondingly, 300a and 300b). In FIG. 4A, FIG. 4B, FIG. 5, FIG. 6A, and FIG. 6B the following items are indicated:
“Top”—connectors for installing said high-performance PCI Express boards mounted on the top surface of backplane 300;
“Bottom”—connectors for installing said high-performance PCI Express boards mounted on the bottom surface of backplane 300;
“1”—the first pin position of said PCI Express connectors and the side of corresponding PCI Express board, where the bracket is located. The backplane 300 (300a and 300b) is fastened to the middle shelves 214 and 204 (FIG. 2) by screws via holes 340a and 340b correspondently. The connectors 301, 302, 311, and 312 are intended for inserting said high-performance boards, correspondingly, 101, 102, 111, and 112. Said connectors 301 and 302 are mounted on the bottom surface of said backplane 300; said connectors 311 and 312 are mounted on the top surface of the backplane 300. All said connectors are ×16 PCI Express, preferably. A Control Unit 400 and Power connector 350 are also allocated on the backplane 300.

The FIG. 4A and FIG. 4B represent two variants that differ by the arrangement of said connectors 301, 302, 311, and 312. The arrangement of said connectors in the first variant is described with respect to the longitudinal line connecting the hole 340a and passing between said holes 340b (FIG. 4A). This longitudinal line divides said backplane into two longitudinal parts and divides, accordingly, said connectors into two groups: (1) 301 and 311, and (2) 302 and 312. The second variant represents another arrangement of said connectors 301, 302, 311, and 312 relative to the transversal line, which separates said connectors into groups of: (1) 302 and 311, and (2) 301 and 312 (left and right in FIG. 4B). One connector in each group is placed on the upper surface of said backplane 300 and another on the bottom surface of said backplane. The choice between said two variants is defined as the length of connections, so and a cost of said PCB, on which said backplane 300 is mounted.

FIG. 5 shows the main electrical connections on said backplane 300. Power for PCI Express cluster is coming via a Power Connector 350. Said Power Connector 350 applies power to the PCI Express connectors 301, 302, 311, 312 and to said Control Unit 400. The Power connector 350 is connected to external Cluster Power Supply (not shown) and receives 3.3V, 12V and ground signals from it via cable (not shown). The Control Unit 400 controls data communication between four PCI Express connectors 301, 302, 311, 312 via PCI Express interface.

FIGS. 6A and 6B represent two diagrams illustrating two different functional implementations of said Control Unit 400.

FIG. 6A represents the first implementation 400a of said Control Unit, wherein said PCI Express Cluster is controlled by an external Host computer (not shown). Said Control Unit 400a includes PCI Express connector 360 and PCI Express Switch 410. The PCI Express Switch 410 is connected to the PCI Express connector 360 and to the four PCI Express connectors 301, 302, 311, 312 via PCI Express Interface. The Host computer (not shown) is connects with the said PCI Express Cluster via the PCI Express connector 360 and a PCI Express cable (not shown). PCI Express Switch 410 allows connection multiple PCI Express ports (four PCI Express boards that suppose to be installed into PCI Express connectors 301, 302, 311, 312 (downstream ports) and PCI Express interface of the Host computer (via PCI Express connector 360 and PCI Express cable; upstream port). In this implementation PCI Express Cluster expands said Host Computer by adding four additional PCI Express slots and allows connecting additionally up to four high-performance PCI Express boards to said Host Computer.

FIG. 6B represents the second implementation of said Control Unit 400b, wherein said PCI Express Cluster operates as a stand-alone device. Said Control Unit 400b includes a Central Processor Units (CPU) 420 that is connected to a flash block 431, a memory block 432, a mass memory 433 (for example, a hard drive memory or corresponding connector for connection hard drive that is not shown) and a block I/O 434. CPU 420 is connected to the four PCI Express connectors 301,302, 311, and 312 via PCI Express interface and controls all operation both CPU and between said CPU and add-in PCI Express high-performance boards that can be plugged into said four PCI Express connectors. Said blocks 432, 431, 433, and 434 are needed for the CPU 420 operation.

We claim:

1. A PCI Express Cluster comprising a backplane, a cluster power supply and a chassis;
said backplane comprises a printed circuit board (PCB), a power connector to connect said backplane to an cluster power supply; a control unit and four PCI Express connectors intended for installing high-performance PCI Express boards; said backplane wherein:
(a) said four PCI Express connectors are mounted on said PCB in parallel to each other;
(b) two of four said PCI Express connectors are mounted on the top side of said PCB, and other two of four said PCI Express connectors are mounted on the bottom side of said PCB:
(c) each two of said four PCI Express connectors that are mounted on one side of said PCB (top or bottom) are oriented to opposite each other directions along said PCB;
(d) said four PCI Express connectors are oriented, thereby that all component sides of said our PCI Express boards, in case when said boards are inserted into said PCI Express connectors, will he directed outward.

2. The cluster according to claim 1, wherein an arrangement of said PCI Express connectors on said backplane and said chassis is adapted for easy installation of said high-performance PCI Express boards chosen from the group, including at least the followings: GPU hoards, Video boards, Special data processing boards, Motherboard in PCI Express hoard form factor.

3. The cluster according to claim 1, wherein said chassis comprises two sections, each of which includes at least three shelves: lower, middle and top shelves, located on three different levels and three said shelves in each section are parallel to each other and connected in series like an incremental staircase;
said cluster, comprising said chassis, wherein said outer shelves (lower and top) belonging to said both sections are intended for fastening PCI Express brackets of said PCI Express boards;
said cluster, wherein said backplane is fastened to said two middle shelves and so that said four PCI Express Connectors oriented perpendicularly to two planes that pass through said sections respectively,
said cluster, wherein said chassis can comprise means for enhancing stability of its position.

4. The chassis according to claim 3, wherein said outer shelves (lower and top) belonging to said both section are additionally connected to each other by an open polygon consisting at least of three rigid bars, and each said open polygon is characterized by two outer bars of said open polygon line are perpendicular to said shelves, and a third central bar is parallel to said shelves.

5. The chassis according to claim 4, wherein said bars can be made in the form of tubes, flat bars or special profiles.

6. The chassis according to claim 3, wherein said two section are mounting in parallel in said chassis and the second section are rotated by 180° about vertical axis compare to first section.

7. The cluster according to claim 1, wherein said power connector is mounted on said PCB and said power connector is electrically connected to said cluster power supply, to each of said four PCI Express connectors and to the said control unit.

8. The cluster according to claim 1, wherein said control unit is electrically connected to each of said four PCI Express connectors and intended for controlling the data communication between said control unit itself and said high-performance PCI Express boards when said boards are inserted into said PCI Express connectors.

9. The cluster according to claim 8, wherein said control unit is able to perform all said functions either by itself in case of stand-alone implementation or under the control of an external host computer, to which said control unit is connected by means of a PCI Express cable.
